(19) United States
(12) Patent Application Publication
(10) Pub. No.: US 2003/0158819 A1
(43) Pub. Date: Aug. 21, 2003

(54) Personal identification device and system used to produce and organize digital receipts

(75) Inventor: Walter G. Scott, North Palm Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc

(21) Appl. No.: 10/284,440

(22) Filed: Oct. 31, 2002

Related U.S. Application Data
(60) Provisional application No. 60/330,794, filed on Oct. 31, 2001.

(51) Int. Cl. G06F 17/60

(52) U.S. Cl. 705/65

(57) ABSTRACT

A system and method are used to authorize a transaction, determine information about the transaction, generate a digital receipt based on the determining step, and store the digital receipt. The determining step can include determining: a time of the transaction, parties to the transaction, a location of the transaction, a service or product purchased during the transaction. The storing step can include storing the digital receipt locally or remotely through a hardwired or wireless local or remote network (e.g., via the Internet, in a personal digital assistant, in an email account, or the like). The method further comprises the steps of categorizing the information from the determining step and organizing the information based on the categorizing.

### RELATED APPLICATIONS

This application claims priority under 35 U.S.C. § 119(e) to U.S. Provisional Application Ser. No. 60/330,794, filed Oct. 31, 2001, which is incorporated herein by reference in its entirety.

### FIELD OF THE INVENTION

The present invention relates generally to a piezoelectric identification device and applications thereof. More particularly, it relates to a device for obtaining biometric information, such as a print, and using the obtained information to recognize and/or identify an individual.

### BACKGROUND OF THE INVENTION

Biometrics are a group of technologies that provide a high level of security. Print capture and recognition is an important biometric technology. Law enforcement, banking, voting, and other industries increasingly rely upon prints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

Optical print scanners are available which detect a reflected optical image of a print. To capture a quality image at a sufficiently high resolution, optical print scanners require at minimum optical components (e.g., lenses), an illumination source, and an imaging camera. Such components add to the overall cost of a print scanner. Mechanical structures to maintain alignment also increase manufacturing and maintenance costs.

Solid-state silicon-based transducers are also available in print scanners sold commercially. Such silicon transducers measure capacitance. This requires the brittle silicon transducers to be within a few microns of the print sensing circuit reducing their durability. To detect a rolled print, the sensing array of the solid-state transducer needs to have an area of 1inch×1 inch and a thickness of about 50 microns. This is a big geometry for silicon that increases the base cost of a print scanner and leads to greater maintenance costs. Durability and structural integrity are also more likely to suffer in such a large silicon geometry.

With an increasing number of people purchasing goods and services using credit cards or via electronic transactions, keeping track of purchases is becoming more difficult and burdensome. Also, even when the purchased receives a receipt or two for each transaction, the store and organization needed to keep track of the paper receipts becomes prohibitive. Further, unless all the individuals in a family or business are meticulous, trying to monitor the transactions of all the individuals for budgetary or legal reasons becomes almost impossible. Currently, a receipt is a non-machine readable device that can be easily lost.

What is needed is an inexpensive, durable print scanner with low maintenance costs. What is also needed is a system and method that will easily and accurately monitor and organize all the transactions of a person or group of people, which also substantially reduces paper receipts.

### BRIEF SUMMARY OF THE INVENTION

Embodiments of the present invention provide a method including the steps of authorizing a transaction, determining information about the transaction, generating a digital receipt based on the determining step, and storing the digital receipt. The determining step can include determining: a time of the transaction, parties to the transaction, a location of the transaction, a service or product purchased during the transaction. The storing step can include storing the digital receipt locally or remotely through a hardwired or wireless local or remote network (e.g., via the Internet, in a personal digital assistant, in an email account, or the like). The method further comprises the steps of categorizing the information from the determining step and organizing the information based on the categorizing.

Another embodiment of the present invention provides a method including collecting personal information from a purchaser during a transaction, collecting transaction information from the purchaser during the transaction, collecting transaction information from a retailer during a transaction, and generating a digital receipt based on said collecting steps, the digital receipt containing information about the collected personal and transaction information.

Systems and methods of the present invention can provide several advantages, such as: biometric level security, the are easily used with ubiquitous handheld wireless devices, they are relatively inexpensive to implement and operate, and they have high licensee integrity (e.g., only licensee can operate them).

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 illustrates system that provides digital receipts of transactions using the wireless transceiver biometric device of FIG. 1.

FIG. 8 is a flowchart depicting a method according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

Embodiments of the present invention provide a system and method used to authorize a transaction, determine information about the transaction, generate a digital receipt based on the determining step, and store the digital receipt. The determining step can include determining: a time of the transaction, parties to the transaction, a location of the transaction, a service or product purchased during the transaction. The storing step can include storing the digital receipt locally or remotely through a hardwired or wireless local or remote network (e.g., via the Internet, in a personal digital assistant, in an email account, or the like). The method further comprises the steps of categorizing the information from the determining step and organizing the information based on the categorizing.

A purchaser who travels to point of transaction is at a disadvantage because details of the transaction that the purchaser receives are in a non-machine readable form that can be lost and not easily duplicated. RF communication allows the purchaser to transfer sufficient information to a vendors transaction monitoring equipment. In turn, that equipment can direct the details of the transaction to a digital storage location of the purchasers choice. This allows for secure data on the transaction in the purchasers to be stored in a purchaser's domain for further analysis and viewing by the purchaser.

This system and method, possible through use of a piconet, can include allow for all required information (e.g., financial, client, business, personal, date, time, place, current trip, who, what, when, why, where, etc.) for a transaction to be digitally sent to a retailers equipment. Then all that information, along with general transaction information, is used to generate and transmit a digital receipt to a storage area requested by a user. This can be via email to a website requested by a user, to a local portable device (e.g., a PDA, cellular phone, etc.). Then further processing can occur on the digital receipt that is not available on paper receipts. For instance, the receipts can be organized by trip, client, expense, etc. so that all digital receipts are easy to handle.

The use of the term “match” or “matching” can be defined as the process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as a one-to-one process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee who template was matched.

II. Wireless Transceiver Biometric Devices

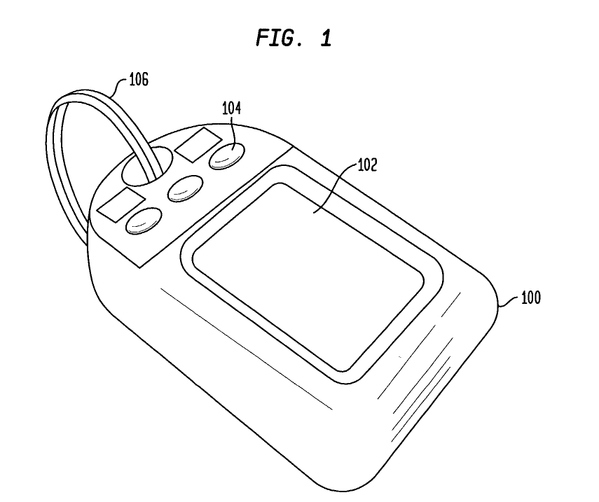

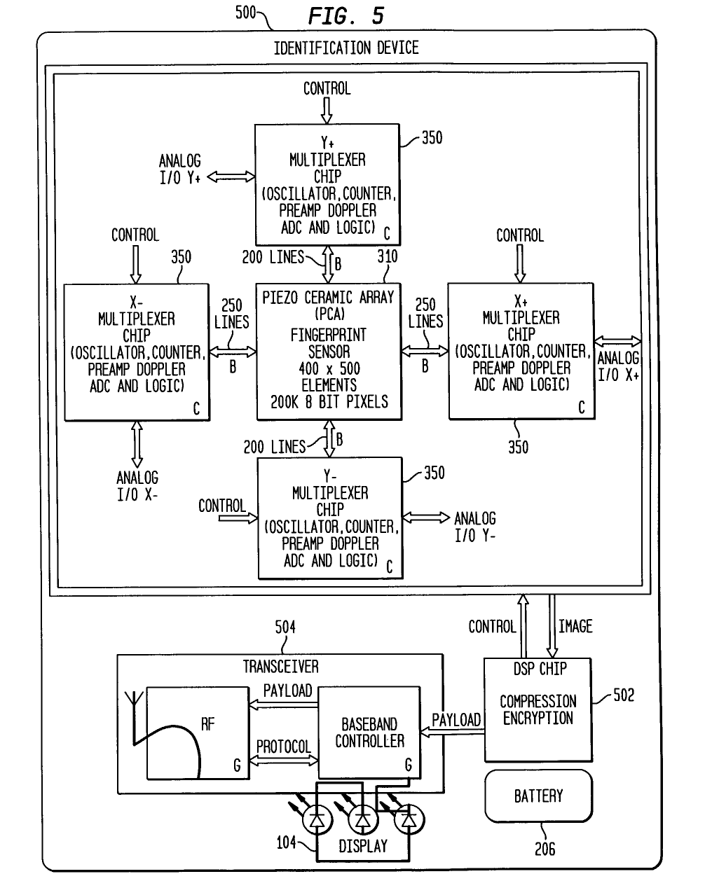

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

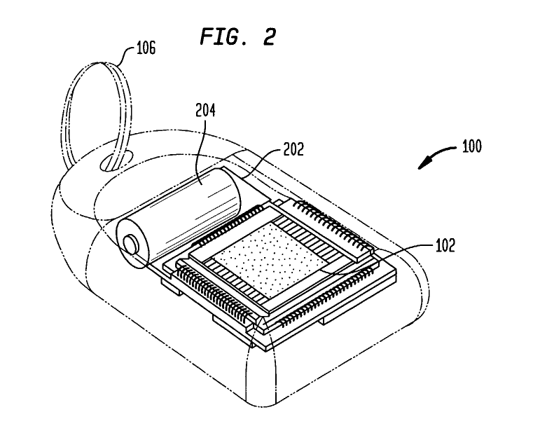

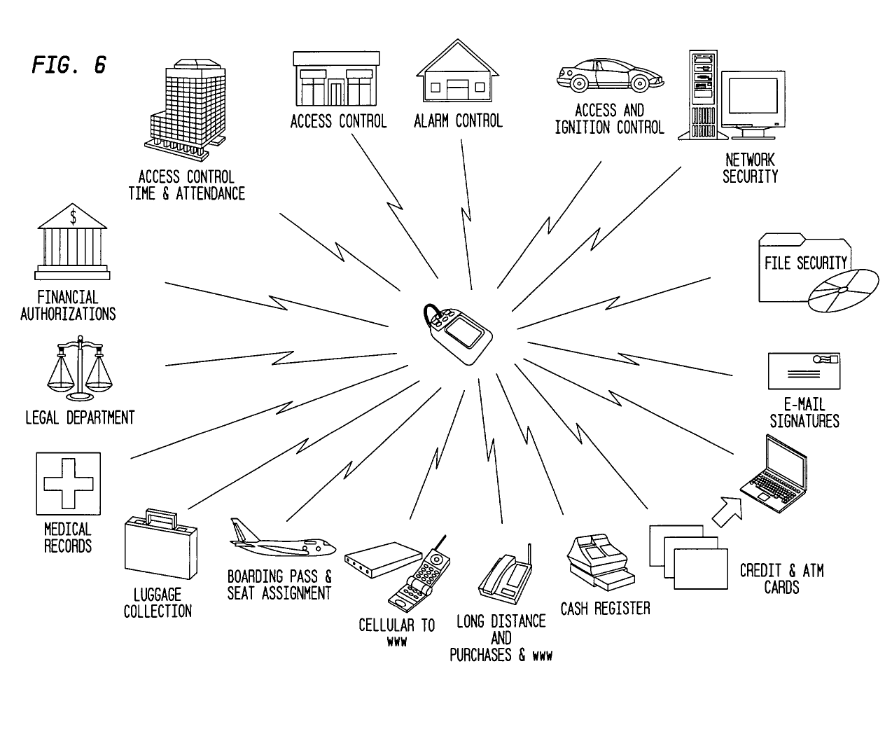

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-8.

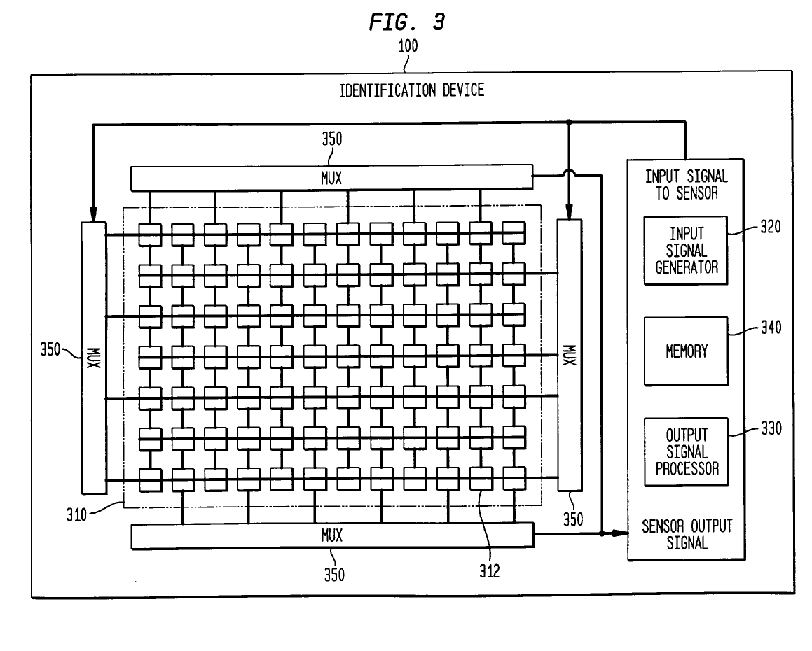

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the 60/330,794 Prov. App, which is incorporated by reference herein in its entirety.

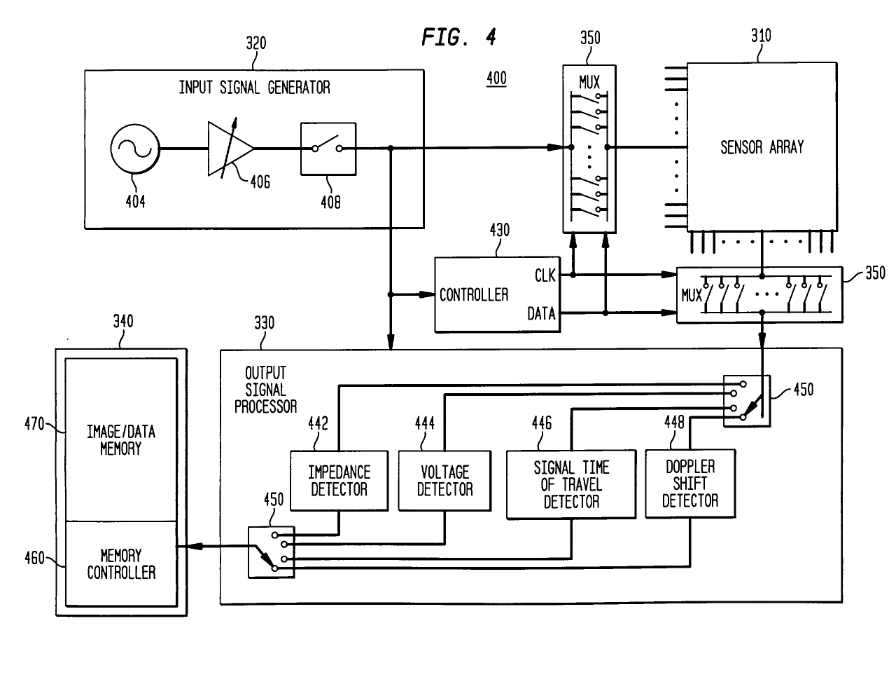

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400, and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc. (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Digital Receipts

Consumers pay a high cost in time spent locating and sorting receipts. There are also a number of tasks involved in dealing with receipts. These tasks include, but are not limited to, auditing, budgeting, cost accounting, and tax collection. The documentation of the details of a purchase transaction, such as time and data of purchase, purchase items, purchase prices, terms, etc., are needed to perform the above-mentioned tasks. Embodiments of the present invention provide a digital receipt that includes the details of a purchase transaction. The digital receipt can be delivered via a wireless device from the vendor's transaction terminal to the purchaser's designated storage medium. A receipt can be defined as a transaction receipt or a purchase receipt. A transaction receipt is a summary document that indicates the vendor, date, and the amount of payment for the product purchased, including taxes paid. The transaction receipt may, in some instances, also include the time of day that the product was purchased. This type of document can be provided to the customer via a credit card company or a bank. The credit card company or the bank are also responsible for maintaining the transaction receipt. A purchase receipt contains all of the data in the transaction receipt, but in an itemized format. This type of receipt is normally confined to paper and provided to the customer during the transaction. Purchase receipts are therefore subject to loss and manual accounting.

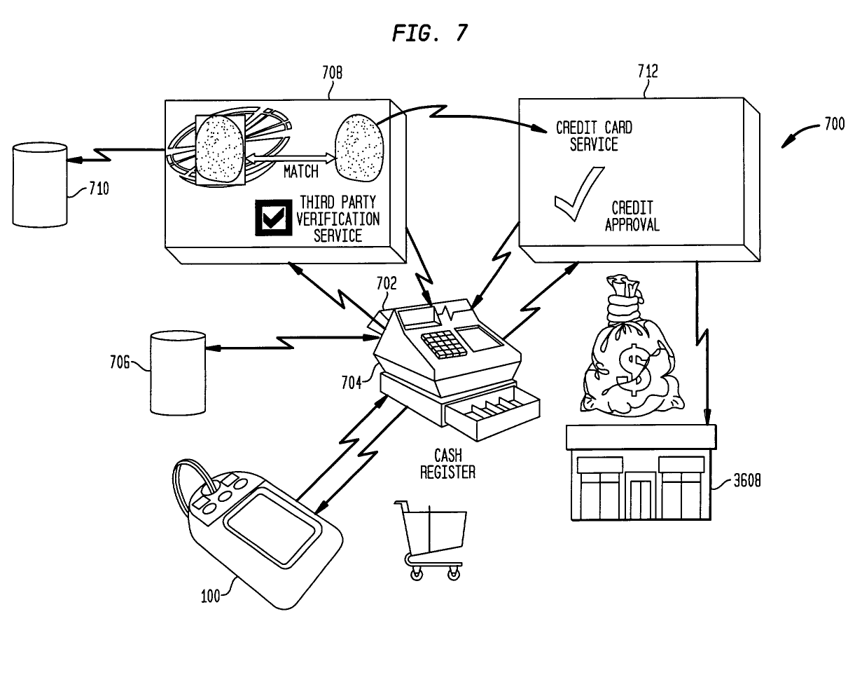

FIG. 7 is a diagram illustrating a system 700 that uses the wireless transceiver biometric device 100 to provide digital receipts to a purchaser's designated storage medium after an electronic sales transaction according to embodiments of the invention. Device 100 is used to obtain a print of the individual (not shown) wanting to make a purchase. Device 100 transmits the print to a device 702 coupled to cash register 704. Although shown as being attached to register 704, device 702 can be remotely coupled via wire, cables, etc. or wirelessly coupled to register 704. Device 100 also transmits the purchaser's identification number and receipt address. The receipt address can identify the storage location of the purchaser's designated storage medium 704. The device 702 coupled to cash register 704 transmits the print to a third party verification service 708. The third party verification service 708 uses the received print to verify the identity of the purchaser by matching the received print to print data stored in a database 710. The identity of the purchaser is then sent to cash register 704 via device 702 and to a credit card service 712.

The credit card service 712 uses the data from the third party verification service 708 to approve sales information received from cash register 704 and to prevent the unauthorized use of a credit card. Once cash register 704 receives verification of the purchaser's identity and verification that the purchaser is authorized to use the credit card service from credit card service 712, cash register 704 notifies device 100 to send a credit card number. Once cash register 704 receives the credit card number from device 100, cash register 704 sends the credit card number to the credit card service 712, which then transfers the money to the seller's bank account to complete the sales transaction. Upon completion of the sales transaction, the device 702 coupled to cash register 704 sends a digital purchase receipt to the purchaser's designated storage medium 706. A confirmation would then be given to the purchaser to indicate that the transaction is complete. In an embodiment, a paper copy of the purchase receipt can also be given to the purchaser, if the purchaser so desires.

In one embodiment, the digital purchase receipt is e-mailed to the purchaser's storage medium 706. In another embodiment, the digital purchase receipt is sent as a packet to a Web address designated by device 100 that is coupled to the storage medium 706. In yet another embodiment, the digital receipt is sent via a wireless network to a personal data assistant (PDA) or a cellular phone of the purchaser that includes the storage medium 706. In a still further embodiment, the digital purchase receipt can be delivered to more than one destination address each having a storage medium 706.

In some embodiments, the unique product identification codes (UPC codes) that are assigned to products for the purpose of bar code scanners can also be held in publicly available web sites so that purchasers and merchants can obtain access to the full product identification. This is useful when a clear text copy of the data for a purchase is not in the digital receipt.

In some embodiments, digital purchase receipts can include, but are not limited to, information about the vendor, the specific time, date, and location of the transaction, the product's warrantee, the purchaser, the purchaser's electronic address, the full UPC code for each product purchased, etc. The digital purchase receipt can also include a universal default chart of accounts category or number for each purchased product for later processing. Such categorizing of products facilitates viewing summaries of purchase records by category or department. In an embodiment, the purchaser can also reclassify a purchased item.

Auditing of the purchaser's file is made easier when the full UPC code is entered in the database. In some embodiments, this data could be supplied to the Internal Revenue Service for auditing and the auditing process could be fully automated.

In yet another embodiment of the invention, a trusted third party service supplier for both vendors and purchasers could receive the digital purchase receipts and process them for various purposes. Such purposes can include, but are not limited to, tax preparation services, expense account services, budget services, administrative services, financial control services, etc. In an embodiment with a financial control service, a person having a credit problem could be prevented by a bank or credit service from making an unwise purchase by denying purchases for luxury items with certain accounting categories. In an embodiment, a councilor could be added to the receipt address to post council advice. Also, in other embodiments a child could be prevented from making alcohol or tobacco purchases and a parolee could be monitored for strict control of time, location, and purchases.

E. Method for Generating Digital Receipts

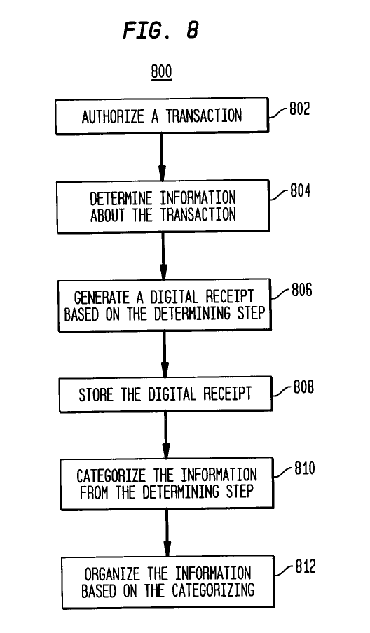

FIG. 8 is a flowchart depicting a method 800 according to embodiments of the present invention (steps 802-808, and optionally 810-812). At step 802, a transaction is authorized. At step 804, information is determined about a transaction. Determining step 804 can include determining: a time of the transaction, parties to the transaction, a location of the transaction, a service or product purchased during the transaction, or any other characteristic of the transaction. At step 806, a digital receipt is generated based on the determining step. At step 808, the digital receipt is stored. Storing step 808 can include storing the digital receipt locally or remotely through a hardwired or wireless local or remote network (e.g., via the Internet, in a personal digital assistant, in an email account, or the like). In some embodiments two additional steps are performed. At step 810, the information from the determining step 804 can be categorized. At step 812, the information is organized based on categorizing step 810.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method comprising the steps of:
authorizing a transaction;
determining information about said transaction;
generating a digital receipt based on said determining step; and
storing the digital receipt.

2. The method of claim 1, wherein said determining step comprises the step of determining a time of said transaction.

3. The method of claim 1, wherein said determining step comprises the step of determining a location of said transaction.

4. The method of claim 1, wherein said determining step comprises the step of determining parties involved in said transaction.

5. The method of claim 1, wherein said determining step comprises the step of determining a service purchased from said transaction.

6. The method of claim 1, wherein said determining step comprises the step of determining a product purchased from said transaction.

7. The method of claim 1, wherein said determining step comprises the step of determining characteristics of a financial exchange during said transaction.

8. The method of claim 1, further comprising the steps of:
categorizing the information from said determining step; and
organizing the information based on said categorizing.

9. The method of claim 8, wherein said categorizing comprises the step of distinguishing between tax related and non tax related ones of said transactions.

10. The method of claim 1, wherein said storing step comprises the step of storing said digital receipt on in a local memory.

11. The method of claim 1, wherein said storing step comprises the step of storing said digital receipt on in a remote memory.

12. The method of claim 11, wherein said storing in a remote memory step comprises the step of transmitting the digital receipt through a network to the remote memory.

13. The method of claim 11, wherein said storing in a remote memory step comprises the step of transmitting the digital receipt through a wireless network to the remote memory.

14. The method of claim 11, wherein said remote memory is in a personal data assistant (PDA).

15. The method of claim 11, wherein said remote memory is associated with an internet address.

16. The method of claim 11, wherein said remote memory is in a local portable device.

17. The method of claim 16, wherein said local portable device includes at least one of a PDA and a cellular phone.

18. A method comprising:
collecting personal information from a purchaser during a transaction;
collecting transaction information from the purchaser during the transaction;
collecting transaction information from a retailer during a transaction; and
generating a digital receipt based on said collecting steps, the digital receipt containing information about the collected personal and transaction information.

19. The method of claim 18, further comprising forward the digital receipt to a predetermined storage location for subsequent access by the purchaser.

20. The method of claim 18, wherein said personal information includes at least one of identity, biometric data, and financial data.

21. The method of claim 18, wherein said transaction information of the purchaser includes at least one of date, time, place, client, and trip information.

22. The method of claim 18, wherein said transaction information of the retailer includes at least one of date, time, place, purchased item, purchased service, cost, and sellers name.
